(19) United States
(12) Patent Application Publication
(10) Pub. No.: US 2016/0261898 A1
(43) Pub. Date: Sep. 8, 2016

(54) PROOFVIEW VIDEO ADVERTISING VERIFICATION

(71) Applicant: GARY GARY, West Mifflin, PA (US)

(72) Inventor: GARY GARY, West Mifflin, PA (US)

(21) Appl. No.: 15/043,564

(22) Filed: Feb. 14, 2016

Related U.S. Application Data
(60) Provisional application No. 62/129,223, filed on Mar. 6, 2015.

(51) Int. Cl. H04N 21/24; H04N 21/478; H04N 21/81; G06Q 30/02; H04H 60/59

(52) U.S. Cl. CPC H04N 21/2407; G06Q 30/0272; H04H 60/59; H04N 21/812; H04N 21/478

(57) ABSTRACT

The Proof-view system, where the system comprises of a computer code, a means, a storage unit, a processor unit and a server. The computer code will overlay on and/or be embedded in video advertising commercials. The means (key board, mouse, captcha etc) is confirm the desired response from the viewer. The storage unit stores a plurality of computer codes to overlay on and/or be embedded in any video advertising. The processor will process the data such as the computer codes or the user's response. The overall system may be store locally or on a remote server.

### CROSS REFERENCE TO RELATED APPLICATION

This application claims priority to and the benefit of U.S. Provisional Patent Application No. 62/129,223, filed Mar. 6, 2015 and titled “ProofView Video advertising verification”; the disclosure of which is incorporated herein by reference in its entirety.

### BACKGROUND

1. Technical Field

The current state of digital video advertising operates much like traditional Television. A commercial plays and is followed by the desired content without any knowledge if the ad was seen. The problem for advertisers is that the majority of advertisements on mobile or web screens are triggered by “bots” not humans. In addition, there is a widespread problem of “view-ability” whereby ads are served on an area of the screen that is not in view of the user. For instance, the ad is playing lower on the page requiring the user to scroll down the page to view it. These problems hurt advertisers because they pay for these useless views. This also hurts premium content creators since the CPM (cost per thousand impressions) is driven down because of this waste resulting in lower revenues to the honest publishers. The only current attempt to validate viewing of video ads is employed by sites like youtube.com. Some ads allow users to “skip ad” after 5 seconds. They incorrectly assume that if a user does not skip (by clicking) the ad, then it is therefore being viewed. It is more likely the user switched to another task while the ad played.

2. Description of Related Art

The purpose of the invention is to provide a means and method whereby video advertisers can determine that a human (not a bot) has viewed a video advertisement/message.

Currently, there is a widespread problem in the growing video advertising space. Advertisers have no method to determine if their messages are viewable on the screen used, or even if a human (not a bot) activated the serving of the advertisement. In addition, even if a human triggers the playing of the AD, there is no method to prove that it was viewed. Often the user looks to other tasks to avoid physically viewing the advertisement. The present invention provides more value to advertisers and will make premium content more valuable.

### BRIEF SUMMARY

The Proof-View technology will overlay on top of and/or be embedded in video advertisements (digital mobile or web) and will first inform the viewer that to access the desired content and/or award the view benefits (i.e. virtual currency, gifts, game attributes), the viewer must view the following commercial message and click/touch an alpha numeric icon when it appears onscreen. The viewer will alternatively be able to enter the alphanumeric character(s) in a validation box in cases where the click/touch action does not register. This backup measure can still allow content access despite a dirty touchscreen or malfunctioning mouse, etc.

The ad will play as normal with the viewer watching. The icon will appear for 2 seconds on the screen during which time the viewer must touch or click the Icon. If the viewer fails to touch/click the Icon while it appears, he/she can manually enter the alpha numeric character(s) displayed in the Icon after the ad has completed. If a viewer fails to correctly touch/click/enter the correct action, they may have the option to play the ad again. A correct viewer action will be sent back to the ad server or a parallel system to register the validation of viewership.

### BRIEF DESCRIPTION OF THE SEVERAL VIEWS OF THE DRAWINGS

Non-limiting and non-exhaustive embodiments of the present invention are described with reference to the following drawings. In the drawings, like reference numerals refer to like parts throughout the various figures unless otherwise specified.

Having thus described the presently disclosed subject matter in general terms, reference will now be made to the accompanying Figures, which are not necessarily drawn to scale, and wherein:

FIG. 1 illustrates the introductory instruction message to credit a user for viewing the commercial advertisement;

FIG. 2 illustrates an Icon appears with the character “G” within the commercial advertisement;

FIG. 3 illustrates the alternate method to get credit for viewing by entering “G” (in this case) in the verification box. Clicking enter tab will send authentication back to the ad system as a proven view.

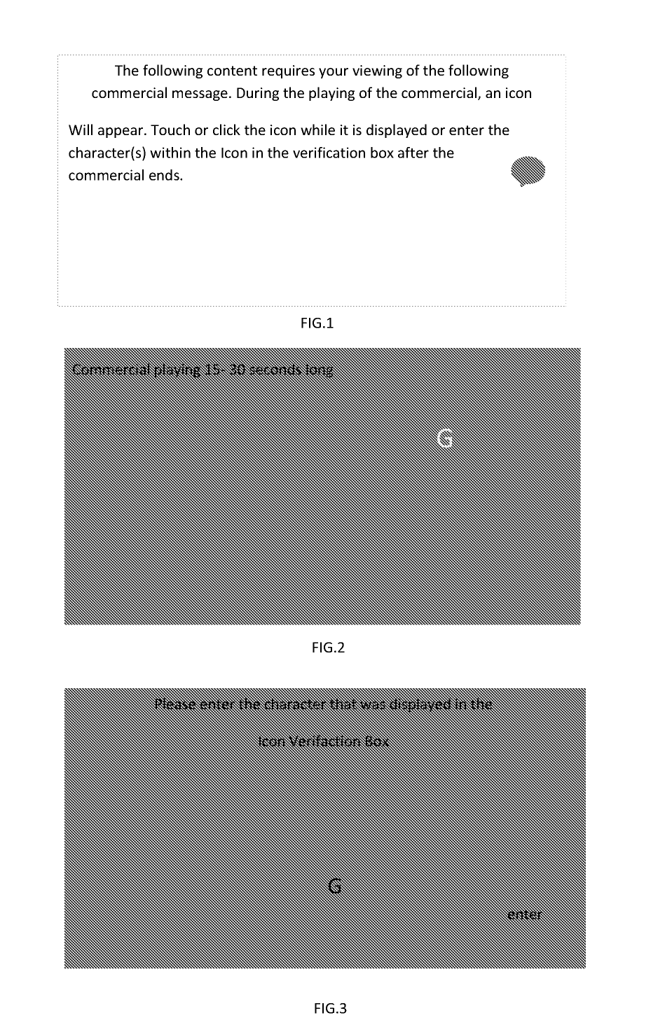

### DETAILED DESCRIPTION

The presently disclosed subject matter now will be described more fully hereinafter with reference to the accompanying Figures, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated Figures. Therefore, it is to be understood that the presently disclosed subject matter is not to be limited to the specific embodiments disclosed and that modifications and other embodiments are intended to be included within the scope of the appended claims.

Reference throughout this specification to “a select embodiment,” “one embodiment,” or “an embodiment” means that a particular feature, structure, or characteristic described in connection with the embodiment is included in at least one embodiment of the disclosed subject matter. Thus, appearances of the phrases “a select embodiment,” “in one embodiment,” or “in an embodiment” in various places throughout this specification are not necessarily referring to the same embodiment.

Furthermore, the described features, structures, or characteristics may be combined in any suitable manner in one or more embodiments. In the following description, numerous specific details are provided, to provide a thorough understanding of embodiments of the disclosed subject matter. One skilled in the relevant art will recognize, however, that the disclosed subject matter can be practiced without one or more of the specific details, or with other methods, components, materials, etc. In other instances, well-known structures, materials, or operations are not shown or described in detail to avoid obscuring aspects of the disclosed subject matter.

All numeric values are herein assumed to be modified by the term “about,” whether or not explicitly indicated. The term “about” generally refers to a range of numbers that one of skill in the art would consider equivalent to the recited value (i.e., having the same or substantially the same function or result). In many instances, the terms “about” may include numbers that are rounded to the nearest significant figure.

As used in this specification and the appended claims, the singular forms “a,” “an,” and “the” include or otherwise refer to singular as well as plural referents, unless the content clearly dictates otherwise. As used in this specification and the appended claims, the term “or” is generally employed to include “and/or,” unless the content clearly dictates otherwise.

The recitation of numerical ranges by endpoints includes all numbers within that range (e.g., 1 to 5 includes 1, 1.5, 2, 2.75, 3, 3.80, 4, and 5).

The Proof-view system is comprised of computer code that will overlay on and/or be embedded in video advertising commercials and once a user clicks to view content/video, a message will appear on their screen instructing the user to click (or type input) the alpha numeric symbol that appears during the playing of the advertising commercials.

The following detailed description should be read with reference to the drawings, in which similar elements in different drawings are identified with the same reference numbers. The drawings, which are not necessarily to scale, depict illustrative embodiments and are not intended to limit the scope of the disclosure.

The overall Proof-view system is comprised of 3 components in sequences:
Sequence 1: A message instructing viewers “that the following content requires your viewing of the following commercial message”. During the playing of the message, an icon will briefly appear on screen. Viewers must have to click or touch the Icon while it is displayed on the screen to access the content. Alternatively, the viewer can manually enter the alpha numeric character(s) displayed in the Icon into a verification box after the commercial is completed.
Sequence 2: The commercial will play and at some point during the commercial, the Icon will displayed/appear on the screen and during the Icon displayed time the viewer can touch/click the Icon to get credit for viewing the commercial. If a user fail to touch/click the icon while it appears on the screen, he/she will have the opportunity to enter the character displayed in the icon into a verification box.
Sequence 3: Post a correct user action (touch/click the icon, or enter the correct character) is completed, the action will be transmitted back to the ad server and/or a parallel system to authenticate/validate that the ad was viewed.

The Proof-view technology can also be employed as a revenue stream by game publishers to allow participation in a game and/or allow a user to gain some attribute of the game (virtual currency, added strength, magic seeds, etc.)

The Proof-view method of implementation will occur at the Ad server level. Ad tech companies employ computer systems (server side) to deliver video advertisements. The same system (or a parallel, independent) system is used for this technology.

While the embodiments have been described in connection with the various embodiments of the various figures, it is to be understood that other similar embodiments may be used or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed is:

1. A system for validating the viewership of any multi-media content, wherein the system comprises:
a computer code, wherein the computer code will overlay on and/or be embedded in video advertising commercials;
a means, wherein the means is configure to confirm the desired response from the viewer;
a storage unit, wherein the storage unit stores the computer codes;
a processor unit, wherein the processor unit processes the computer code and the user's response; and,
a server.

2. The computer code as claimed in claim 1, wherein the computer code will be executed as a display message on the screen, wherein the execution of the computer code is linked to the click of the user for viewing of content/video of the user.

3. The message as claimed in claim 2, wherein the display message will instruct the user to input the alpha numeric symbol that appears during the playing of the advertising commercials.

4. The message as claimed in claim 3, wherein the display message will be played at a user defined time period, the user can get credit for viewing the commercial by touch/click the message and/or enter the character displayed in the message in the icon into a verification box.

5. The credit as claimed in claim 4, wherein the credit is transmitted back to the server and/or a parallel system to authenticate/validate that the ad was viewed.
